(19) United States
(12) Patent Application Publication
(10) Pub. No.: US 2025/0017701 A1
(43) Pub. Date: Jan. 16, 2025

(54) Dental Implant

(71) Applicant: Rambo Implant Limited, London (GB)

(72) Inventor: Rami YOUSSIF, London (GB)

(21) Appl. No.: 18/714,294

(22) PCT Filed: Nov. 30, 2021
(86) PCT No.: PCT/GB2021/053124

§ 371 Date: May 29, 2024

(51) Int. Cl. A61C 8/00

(52) U.S. Cl. CPC A61C 8/0031; A61C 8/005; A61C 8/0089

(57) ABSTRACT

A dental implant comprising an implant platform and a strap, wherein the strap encircles the lower mandible, affixing the implant platform to the lower mandible.

### FIELD

The present disclosure relates to dental implants, specifically to a dental implant for inserting into the lower mandible.

### BACKGROUND

A dental implant is a surgical component that interfaces with the bone of the jaw or skull to support a dental prosthesis such as a crown, bridge, denture, facial prosthesis or to act as an orthodontic anchor.

Dental implants rely on osseointegration, a biological process in which the material of the implant, such as titanium, forms an intimate bond to bone. The implant fixture is first placed so that it is likely to osseointegrate, and then a dental prosthesis is added. A variable amount of healing time is required for osseointegration before either the dental prosthesis is attached to the implant or an abutment for holding a dental prosthesis is connected to the implant.

There are numerous risks and complications relating to current procedure, relating to pre-surgery, during surgery and post-surgery. For example, pre-surgery conditions affecting the success or failure of implants include the health of the person receiving the treatment, medication which affects the chances of osseointegration, and the health of the bone and tissues in the mouth. The prerequisites for long-term success of osseointegrated dental implants are healthy bone and gingiva. Since either bone or gingiva can atrophy or degenerate after tooth extraction, pre-prosthetic procedures such as bone grafts, sinus lifts or gingival grafts are sometimes required to recreate ideal bone and gingiva.

Where there is significant bone loss, it is very difficult to place a conventional implant as a tooth replacement method. To replace the bone alternative methods are available such as autogenous bone graft from the ramous of the mandible or chin. These procedures have only a 60% success rate and in addition can be uncomfortable for the patient. Factors such as increased risk of post-operative infection and the difficulty of the procedure itself, which is highly demanding for the dentist, mean failure of bone grafting or integration is common.

Placement of dental implants is a surgical procedure and carries the risks of surgery including infection, excessive bleeding and necrosis of the flap of tissue around the implant. Nearby anatomic structures, such as the inferior alveolar nerve, the maxillary sinus and blood vessels can also be injured when the osteotomy is created or the implant placed. An inability to place the implant in bone to provide stability of the implant (referred to as primary stability of the implant) increases the risk of failure to osseointegrate and further damage to the surrounding tissue.

Current procedures also carry risks related to biomechanical factors, where the geometry of the implant does not support the teeth in the same way the natural teeth did such as when there are cantilevered extensions (fewer implants than roots or teeth that are longer than the implants that support them or a poor crown-to-root ratio). Similarly, grinding teeth alongside a lack of bone or low diameter implants increase the biomechanical risk. Finally, there are technological issues, where the implants themselves can fail due to fracture or a loss of retention to the teeth they are intended to support.

### SUMMARY

An aspect of the present disclosure relates to a dental implant, comprising an implant platform and a strap, wherein the strap is suitable for encircling the lower mandible so as to affix the implant to the lower mandible.

The term “dental implant” is intended to mean an assembly, for example an implant platform, strap and abutment. The implant platform may be capable of receiving an abutment. The abutment may be suitable for securing a dental prosthesis e.g. a crown, bridge or denture, or any other suitable means for securing a crown, bridge or denture, or other prosthesis. In one embodiment, the implant also includes the dental prosthesis.

The strap may be a flexible sheet. The strap may have a plurality of apertures forming a mesh. The apertures may be circular or hexagonal in shape. The apertures may have a diameter of 0.7 mm, or when hexagonal, a widest dimension of 0.7 mm. The apertures provide “breathing space” for the bone of the lower mandible, thereby mitigating the natural tendency of the bone to resorb in response to an implant and also providing apertures to encourage the bone to osseointegrate.

The strap is configured to entirely encircle the lower mandible. The tissue around the lower mandible may be dis-engaged from the mandible (also known as “elevated”) by the dentist so that the strap sits against the bone, the tissue may then be re-fixated. This arrangement works uniquely on the lower mandible because of its shape and because the blood supply and cranial nerve are in a channel (a foramen) which goes through the centre of the lower mandible. Therefore, a dentist can displace the tissue surrounding the lower mandible without damaging the nerve or blood supply. As such, the mechanism of wrapping the strap around the bone is possible for this specific anatomy, without damaging the anatomy. This arrangement avoids the need to drill into the bone.

The strap may comprise a means for engaging the implant platform. The implant platform may comprise a mandible facing surface which may be substantially flat and configured to sits on the mandible surface. In another embodiment the mandible facing surface comprises a projection for insertion into a mandible. In an alternative embodiment, where there is a projection, or where the retention is poor, a pilot hole may optionally be created by the dentist at a position where such a hole would be drilled through the cortical bone but would not pierce the cortical plate of the mandible. The projection may be inserted into the pilot hole. It will be appreciated that, for traditional implants that are implanted into the bone mass of the lower mandible, a minimum volume of bone is required to provide sufficient anchoring for the implant and to prevent the implant from approaching the nerve that runs in the lower mandible. Thus, for patients with weakened or thinned lower mandibles it can be necessary to increase the volume of bone available at the implantation site.

As the dental implant of the embodiments is anchored to the lower mandible by the strap and does not need to penetrate the bone structure of the lower mandible, thus the embodiments described herein avoids the need for bone grafts or distraction of the bone. Where a pilot hole is required, the depth required is significantly less than for conventional implants. The dental implant may be used for replacing any tooth on the lower mandible. Preferably, the dental implant is suitable for replacing teeth at the distal portion of the lower mandible.

The strap is configured to be long enough to completely encircle a portion of the lower mandible. Thus, the strap is substantially rectangular in shape having two ends and two long sides. The strap may be thin so that the surrounding tissue can be returned to its position around the strap, thereby minimising trauma to the area. Preferably, the strap is between 0.05 mm and 0.25 mm in thickness.

The strap ends may meet at the top surface of the lower mandible at the position where the original tooth root was. The strap ends comprise a means of attaching to each other or to the implant platform, or both. The strap may be secured such that it cannot move circumferentially or axially relative to the lower mandible. This ensures that the lateral and occlusal forces acting on the lower mandible and on the surrounding teeth are minimised, for example during chewing etc. The strap may be flexible. The strap may be elastically deformable to fit against the lower mandible.

In an embodiment, in place of apertures the strap may be composed of a plurality of loops or rings, such as metal rings, that are interlinked with other rings that neighbour the ring structure in at least two orthogonal directions so as to form a two dimensional sheet structure, similar to the structure of chainmail. The small metal rings may be machined, produced using additive manufacturing, laser cutting or any other suitable technology. If individual loops are formed these loops may subsequently be interlinked with each other in the above described manner. Alternatively, if the rings are created using additive manufacturing, the rings can be created in a fashion so that they are already interlinked as the rings grow and before they are closed. The holes in the metal loops also provide “breathing space” for the bone of the lower mandible, as discussed in relation to the strap apertures.

Alternatively, the strap may be composed of woven threads or comprise a section that is so composed. The woven structure may be woven so that no apertures are left between adjacent threads or more loosely woven, for example to provide apertures of at least one thread with between adjacent threads. Loosely woven threads provide similar benefits to the apertures of the strap, for example “breathing space”. The woven threads may be metal. Alternatively, the woven threads may be a polymer material such as, for example, polypropylene or PTFE. The woven threads may be thin enough to allow flexibility. The structure may resemble a rectangular shaped woven sheet.

Where the strap structure is made from metal threads or chainmail it may comprise laser welded intersection points at the peripheral edges, at the ends and/or the long side edges, to secure the threads in position and increase stability of the strap. Alternatively, some or all of the ends and long side edges of the woven material may be bonded by chemical, mechanical, heat or solvent treatment. The strap may alternatively be composed of a combination of chainmail and woven threads and the peripheral edges may be bonded by any of the methods discussed above.

The strap may comprise a metal material capable of integrating with bone. The metal material may be titanium. Alternatively, the material may be medical grade steel, cobalt chromium, Zirconium, a titanium alloy or a medical grade polymer. Additionally or alternatively, any material comprising mechanical properties suitable for use as a dental implant, i.e. appropriate wear properties, tensile and compressive strength, fracture toughness, could be used.

In one embodiment, the strap is treatable to introduce shape memory properties to a portion of the strap. This could be useful for patients with unusual anatomies, for example while the typical lower mandible cross section is substantially ellipsoidal, a lower mandible could conceivable be fabiform or “bean shaped”. Where a patient has such an anatomy, there would be a gap between the encircling strap and the concave portion of the lower mandible. Therefore in one embodiment, a strap comprising NiTi alloy may be heat treated to form a stiffer and curved portion which may fit such bone shapes. A dentist could use X-rays or CT scans to establish the anatomy of the patient and establish whether this property is necessary.

The strap is configured to completely encircle the lower mandible. This makes the implantation procedure safer; since depending on the mandible, in certain circumstances, no drilling may be required, thus risk of fracture of the bone or drilling into the cranial nerve or the blood supply at the centre of the bone is significantly reduced or at least mitigated.

The strap is configured such that it is flexible and may fit closely against lower mandibles of varied geometries and thus be suitable for various patients. The strap may be sized such that it is the width of a single tooth. Alternatively, the strap may be adjustable in size depending on the patient's anatomy. The dentist may have the option to use X-rays or CT scans to establish the anatomy of the patient and the strap may be machined to fit or simply cut to size by the dentist before implantation in response to the patient's anatomy, thereby providing versatility and patient-customisability.

Preferably, the strap is not tight enough to exert pressure on the lower mandible but sits intimately enough to allow the bone to osseointegrate. This provides a way of implanting a tooth implant without drilling into the bone. However, in practice and at the dentist's option, a shallow pilot hole could be created to take a cylindrical mandible project which would be advantageous.

The strap may comprise a means for engaging the implant platform. The means for engaging the implant platform may comprise cantilever arms, or receiving apertures, which engage with complementary features on the implant platform. The strap is configured to attach to the implant platform, holding it in position against the lower mandible. The strap may instead be attached to any type of implant which has suitable fasteners.

The strap may, for example be permanently attached to a first side of implant platform and either or both of the implant platform and the strap may comprise attachment means such that the strap may attach to the implant platform on an opposite side of the implant platform to the first side. For example, the strap may be already affixed to the platform and in use the free end of the strap is wound around the lower mandible and the free end is then connected to the opposite end of the strap or directly to the platform.

Alternatively, the strap comprises cords which may be tied to an eyelet or other hoop structure on the implant platform. The attachment means on the strap may comprise at least one loose end or cord at one of the ends of the strap. Alternatively, the strap may comprise two or four cords at two or four of the corners of the strap. Where the strap comprises one or two cords on just one end, the strap may also comprise an alternative means for attaching to the implant platform at the other end.

The attachment means may be configured to not only attach the strap to the implant platform but to also allow in use tightening, preferably a gradual tightening, of the strap around the lower mandible whilst maintaining or increasing a connection between the strap and the implant platform. In another embodiment, the strap is not permanently attached to the implant platform on one side. Instead, the above described gradually tightenable attachment means may be provided on both sides of the implant platform.

Alternatively, the strap and implant platform may be configured so that the strap can be securely anchored to one side of the implant platform and a gradually tightenable attachment means is provided upon a side opposite to the side to which the strap is anchored. In yet another embodiment a gradual tightening means may be provided that allows relative gradually tightening movement of the two strap ends relative to each other whereby such tightening movement increases tightening engagement with the tightening means. The implant platform may be connected to the tightening means, for example so that it rides on top of the tightening means opposite to the side of the tightening means that is closest to the lower mandible. It is not essential for the strap to be tightened to a degree that friction anchors the implant platform to the lower mandible. Anchoring is preferably instead provided by osseointegration with the strap or with apertures therein.

The implant platform may be generally cuboid in shape. The implant platform may have one surface which, in use, touches the bone surface. The bone touching surface may be the “bottom” face of the implant platform. The implant platform may have a second surface, situated opposite the bone touching surface. The second surface may comprise an area configured to hold an abutment and a dental prosthesis. A dental prosthesis may sit in the centre of the platform, thus the tooth implant holding area may be at the centre of the platform. The platform may provide a securement area for the tooth implant in cases of recessed bone tissue without the need for grafts or distraction of the bone.

The tooth implant holding surface may be the “top” surface of the implant platform. The top surface of the implant platform may additionally have an attachment means for attaching the strap to the implant platform. The strap attachment means may be a protrusion, or a fastener, series of protrusions/fasteners suitable for engaging cantilever arms or receiving openings on the strap. The strap attachment means may be provided at one or both sides of the tooth implant holding area. The strap attachment means may comprise a protrusion/fastener capable of interfacing with an engagement feature on the strap. The terms “engagement means” and “attachment means” are used interchangeably herein. The protrusion/fastener may be integrally formed with the implant platform. The protrusion/fastener may be machined into the implant platform. Alternatively, the protrusion/fastener may be a separate component which has been affixed to the implant platform.

The fastener may be a wire lock pin type fastener, cable clamp with push mount, nail cable clip, a buckle type clip or any other fastening means suitable for attaching a loose end to a surface. Alternatively or in addition, the dentist could tie the fastening means on the strap in a surgeon's knot or constrictor knot around a loop fixture. There may be a plurality of fasteners.

The implant platform may comprise a metal material capable of integrating with bone. The metal material may be titanium. Alternatively, the material may be medical grade steel, cobalt chromium, Zirconium, a titanium alloy or a medical grade polymer. Additionally or alternatively, any material comprising mechanical properties suitable for use as a dental implant, i.e. appropriate wear properties, tensile and compressive strength, fracture toughness, could be used.

The bone touching surface may be curved to fit the contours of the top surface of the lower mandible. The bone touching surface may be coated. The coating may be hydroxyapatite, fluoride or calcium-based material. The coating may be any other material for increasing surface area or promoting bone attachment or ingrowth. The bone touching surface may also or instead be roughened, for example using a sand blasting technique, to increase surface area for attachment to the bone or ingrowth.

In an embodiment, the mandible facing surface may comprise a means for stabilising the platform relative to the mandible. The means for stabilising the implant platform may comprise spikes for engaging the mandible and preventing rotation. The spikes may be provided in a circular array, positioned concentrically about a mandible facing projection. However, it will be understood that the spikes may be in other configurations. The spikes may be pyramidical, terahedrical, conical protrusions. Other suitable geometries for engaging the bone surface are envisaged.

The centre of the platform may have a recess which is suitable for an abutment. Alternatively, the implant platform comprises a projection for receiving an abutment. The projection or recess geometry may be complimentary to the abutment so that the two components may fit together. The abutment receiving projection may comprise a means of anchoring the abutment to the projection once connected. This anchoring means may be mechanical, a coating or any other suitable means. The means of anchoring the abutment may be a threading on the engaging surfaces of the abutment and the projection. In one embodiment the threading on the outer surface of the projection may be complimentary to a thread on an inner surface of an abutment. The abutment receiving projection may comprise a guide for positioning a dental prosthesis.

A benefit of the described arrangement is that the abutment and dental prosthesis may be replaceable. During the current procedures, when an implant is inserted directly into the bone it fuses with the surrounding bone, therefore, where replacement of the implant is necessary, there is a high risk of fracture of the bone during the removal procedure. In the arrangement of the present invention, the implant platform can stay in position and an abutment and crown can be replaced as many times as necessary. For example, younger generations with implants are more likely to need a replacement implant in their lifetime, because bone naturally resorbs over time and with age. The resorbed bone provides less material to attach to and thus, where further drilling is required for the replacement implant, the implant gradually gets closer to the cranial nerve and blood supply.

In an embodiment, in place of a mandible facing projection the implant platform may comprise a small hole in the bottom, or bone surface facing side. A pilot screw may be inserted through the hole and screwed into the bone underneath. The head of the screw will be bigger than the hole, so that only the threaded part of the screw may fit through the hole. Thus, when the pilot screw has been screwed into the bone beneath the implant platform the implant platform is pinched between the bone and the head of the screw.

Alternatively, there is an additional anchoring means on the pilot screw or mandible facing projection to increase the surface area of the contact between it and the surrounding bone. These configurations provide further stability to the implant and prevent any unnecessary and potentially harmful movement of the implant platform. This is particularly important soon after implantation, before the bone has had time to osseointegrate with the implant and or strap.

In embodiments where a pilot screw is required, the pilot screw may be small relative to the lower mandible. The pilot screw may be 1-4 mm in length. Therefore, it does not pose any risk of damaging the centrally positioned cranial nerve or blood supply.

According to an embodiment there is a method of training comprising the following steps; instructing a dentist to: (i) make a crestal incision on the top side of the mandible; (ii) reflect a flap of the gum/gingiva circumferentially around the mandible to create some space between gum and bone; (iii) fit the implant platform on the top surface of the mandible so as to be in contact with the upper surface of the lower mandible; (iv) wrapping the strap around the lower mandible; and (v) securing strap ends to the implant platform thereby securing the implant platform to the mandible.

### BRIEF DESCRIPTION OF FIGURES

FIG. 1 illustrates a perspective view of an exposed mandible;

FIG. 2 shows an implant platform in-situ on a mandible;

FIG. 3 shows an implant with a strap encircling the mandible, implant platform and strap;

FIG. 4 shows an implant with a strap encircling the mandible, implant platform and strap;

FIG. 5 shows an implant with a strap further encircling the mandible, implant platform and strap;

FIG. 6 shows an implant with a strap encircling the mandible and implant platform and fixed to the implant platform;

FIG. 7 shows an implant with a strap encircling the mandible and implant platform and a threaded ferule;

FIG. 8 shows an implant with a strap encircling the mandible and implant platform and a threaded ferule;

FIGS. 9 A and B show top side and underside perspective views of an implant platform according to an embodiment;

FIG. 10 depicts an implant platform according to an embodiment;

FIG. 11A shows an abutment according to an embodiment;

FIG. 11B shows an abutment affixed to an implant platform according to an embodiment;

FIG. 12A shows an implant platform according to an embodiment;

FIG. 12B shows an abutment affixed to an implant platform according to an embodiment;

FIG. 13A shows straps according to embodiments;

FIG. 13B shows apertures on the strap;

FIG. 14 shows a strap according to an embodiment;

FIG. 15A-D show various strap buckle geometries according to embodiments;

FIG. 16 shows a buckle according to an embodiment;

FIGS. 17A and B show straps according to embodiments;

FIGS. 18A and B show implant platforms according to embodiments;

FIG. 19A-D show implants according to embodiments;

FIG. 20A-D show implants according to embodiments;

FIG. 21A-D show implant assemblies according to embodiments;

FIG. 22A-D show threaded ferules and a tool according to embodiments;

FIGS. 23A and B show implant platforms according to embodiments;

FIG. 24 illustrates an implant platform according to an embodiment.

### DETAILED DESCRIPTION

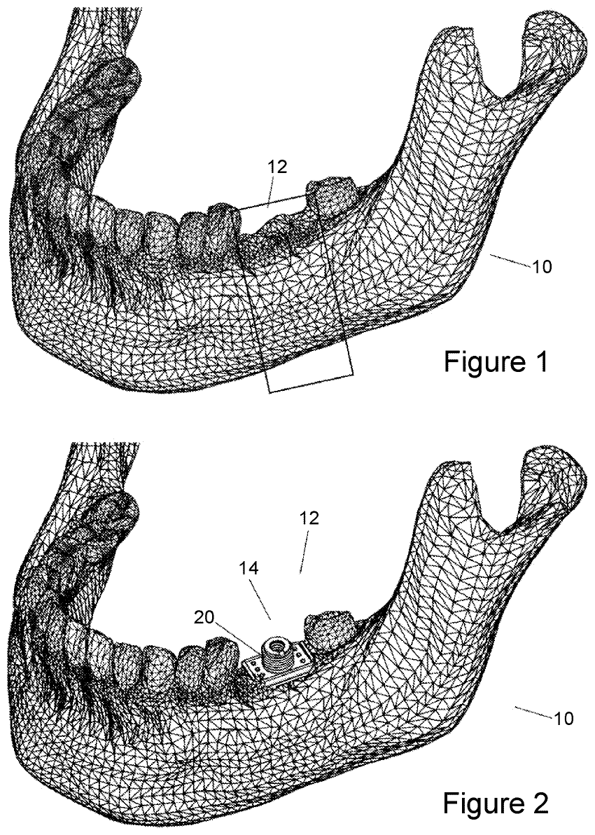

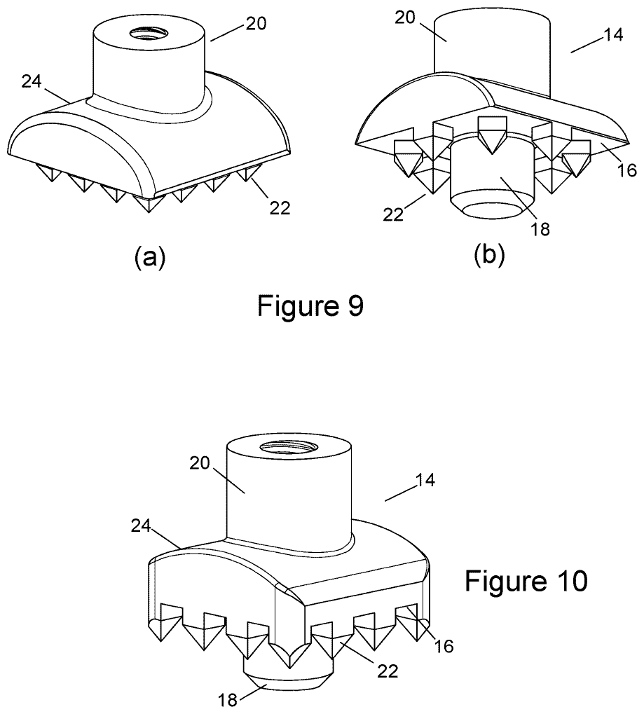

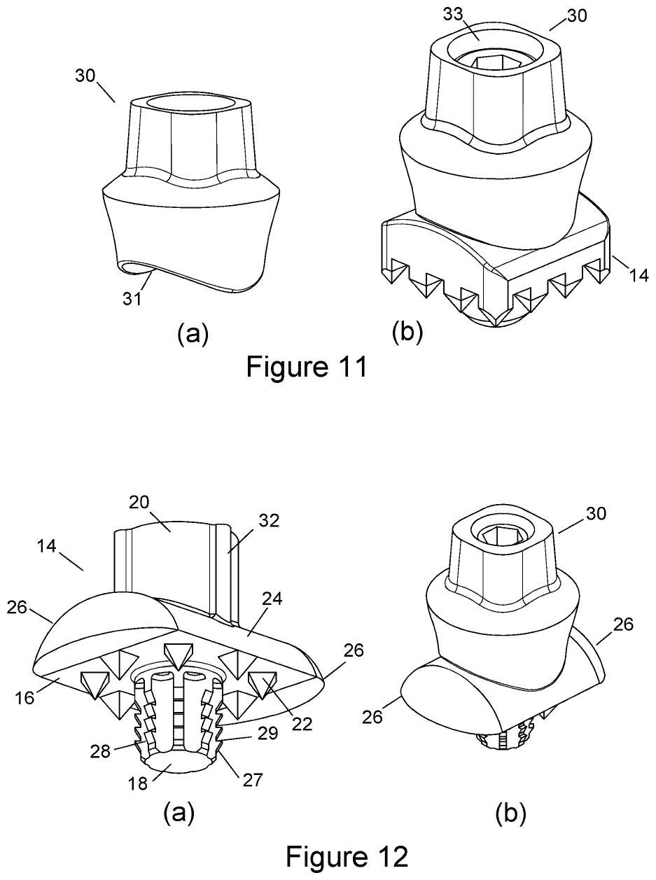

FIG. 1 to FIG. 8 show the lower mandible 10 in various stages during insertion of the implant. The implant comprises an implant platform 14 for insertion into the mandible 10, a strap 40 for securing the implant platform 14 in place and an abutment 30 (as shown in FIG. 11) fixable to the implant platform 14 and for receiving an implant crown (not shown). Various examples of implant platforms, straps, abutments and combinations therefore are shown in FIGS. 9 to 24.

FIG. 1 depicts the lower mandible 10. Prior to the procedure, a section of the lower mandible 10 is exposed by displacing/dis-engaging/“elevating” surrounding tissue encircling the mandible to show the site 12 for implantation. A section surrounding the mandible 10 is dis-engaged, for example in FIG. 1 the section of tissue approximately within the black box is displaced to expose the bone. This can be done by anaesthetizing the patient using an appropriate nerve bloc agent. A crestal incision is made on the top side (occlusal) where the back tooth and front tooth lie using a scalpel. A periosteal elevator is used to reflect the flap of the gum/gingiva and the dentist can continue to reflect the flap circumferentially. This creates some space between the gum and the jaw. The dentist can then shave the jaw bone if deemed necessary.

In FIG. 2 the site 12 for the implant has been exposed for the implant. In some embodiments, the implant is placed directly on top of the mandible at site 12. In other embodiments, a small hole is drilled to a maximum depth of 2.5 mm to receive the implant platform 14. Where a small hole is used, a projection at the base of the implant platform 14 is inserted into the small hole to secure it in position such that the rest of the implant platform 14 sits on top of the mandible.

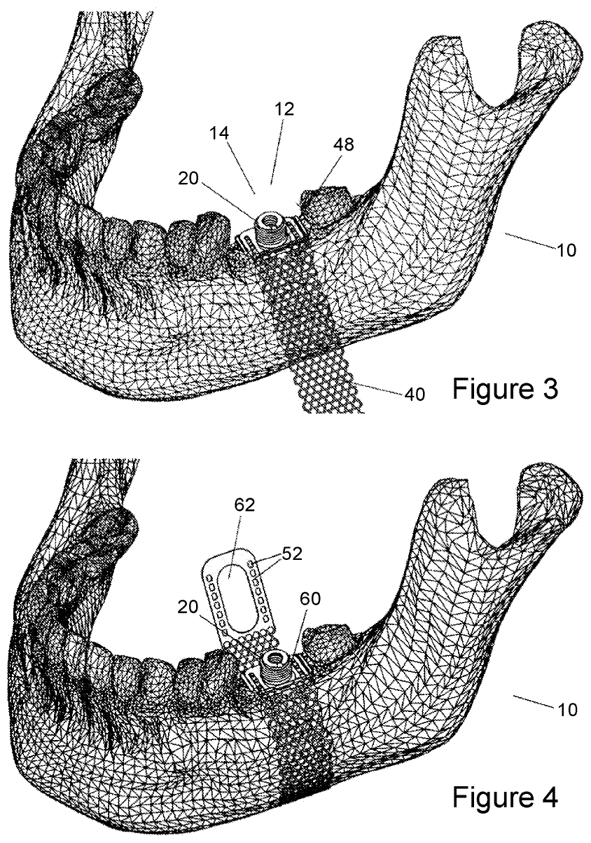

As shown in FIG. 3, an end of the strap 40 connects with the implant platform 14 and is wrapped around the mandible 10. In FIG. 3 an embodiment of the strap is shown wherein a first end of the strap 40 with an opening 48 is looped over the abutment receiving projection 20 of the implant platform 14. The orientation of the implant is influenced by the drape of the strap 40 over the bone, thus the dentist is provided with the opportunity to adjust the orientation of the implant platform by adjusting the drape of the strap 40 over the mandible 10, making it possible to match the implant placement to the surrounding teeth.

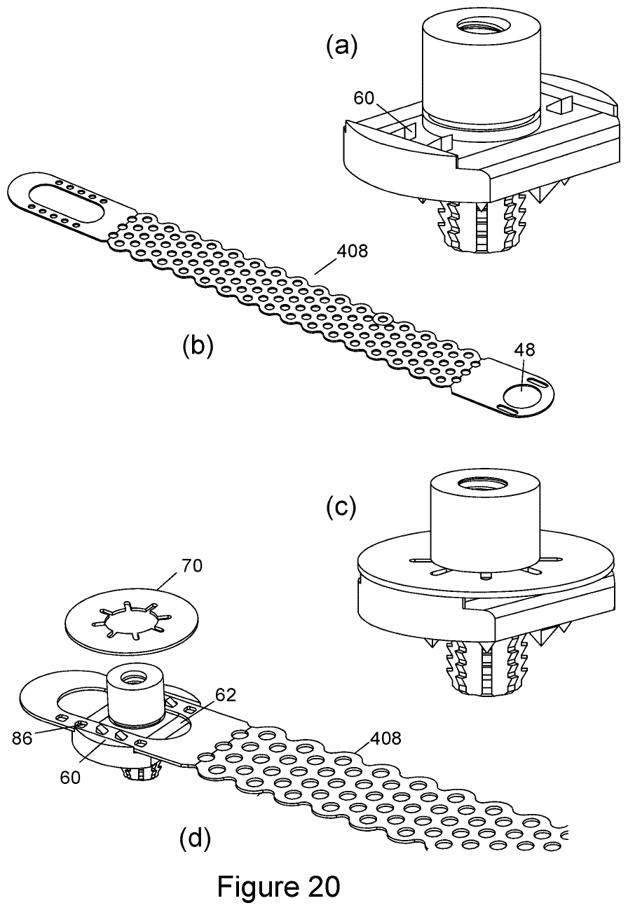

Depicted in FIG. 4, the strap 40 is wrapped around the mandible and aligned so that the engagement features 52 of the strap 40 engage protrusions 60 (in the example shown in FIG. 20D four such protrusions are shown but it will be appreciated, not least so from other figures disclosed herein, that other numbers of protrusions may instead be provided) on the implant platform 14. In the embodiment shown, an elongated opening 62 at the second end of the strap 40 connects with the implant platform 14, by looping back over the abutment receiving projection 20, and aligns end of the strap 40 relative to the rest of the strap 40.

FIG. 4 depicts the strap 40 looped around the mandible 10. The surface of the strap 40 is flat, ensuring that the strap 40 is laid flat over the bone. The surface of the strap 40 is compliant to the convex surface of the bone creating an intimate contact. However, the strap 40 bridges concave surfaces of the bone. In another embodiment the strap 40 is wrapped loosely around the bone of the mandible initially before looping the ends of the strap 40 onto a projection 20 of the implant platform 14.

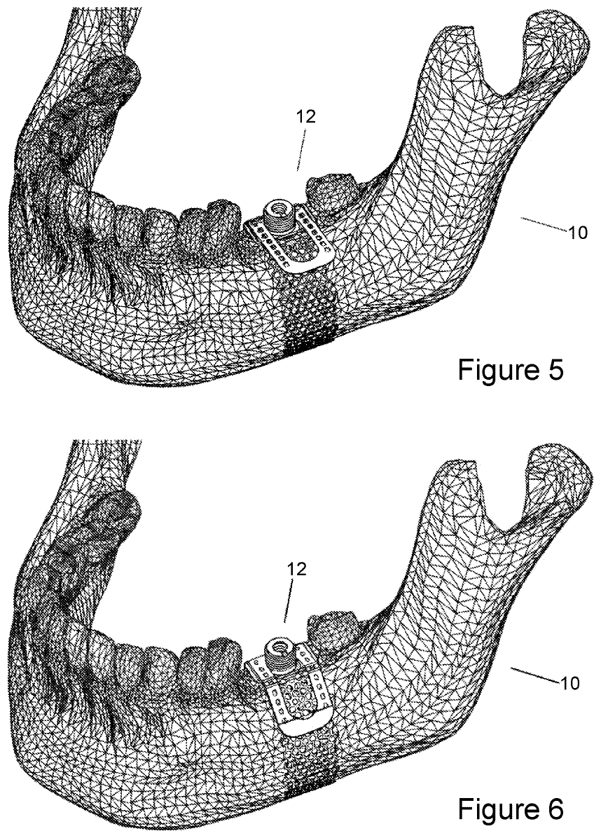

FIG. 5 illustrates the end of the strap 40, with the elongated opening 62, looped over the projection 20 firmly and shows the engagement between engagement features 52 and protrusions 60.

FIG. 6 is a schematic showing a perspective view of the implant platform 14 and strap 40 in situ on the exposed lower mandible. As shown in FIG. 6 the loose end of the strap 40 is smoothed down onto the surface of the bone. In some cases, the loose end of the strap 40 may be further secured using sutures, or removed.

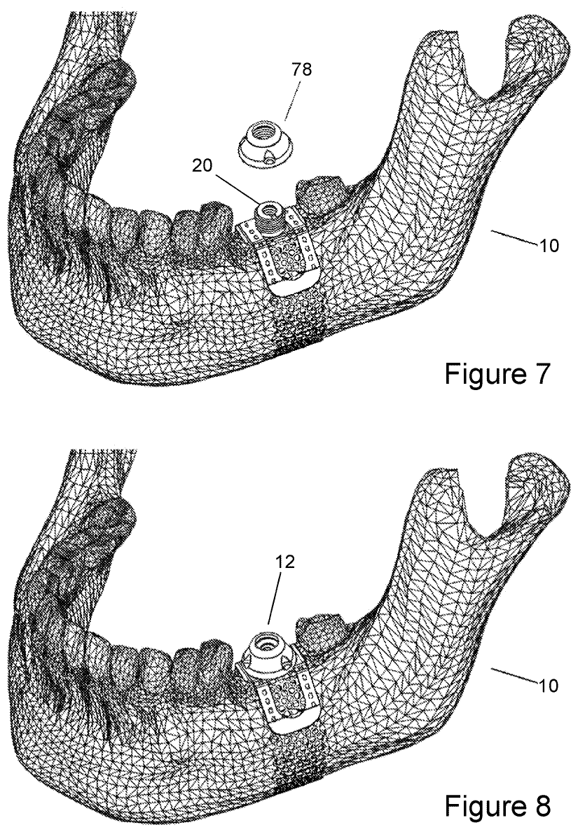

As FIG. 7 shows, in some embodiments, a threaded ferule 78 is gently guided onto the projection 20 of the implant platform 14 to pinch the strap 40 between the threaded ferule 78 and the implant platform 14. As illustrated by FIG. 8 the threaded ferule 78 firmly holds and secures the two ends of the strap 40 together. FIG. 8 is a schematic showing the implant platform 14, strap 40 and threaded ferule 78 in situ on the lower mandible 10.

As will be shown in subsequent figures, an abutment 30 is affixed to the implant platform 14 and/or threaded ferule 78. Subsequently, a crown or replacement tooth is fitted on the abutment 30 such that the tooth sits above the implant and at the same level as the surrounding teeth.

Specific features of the implant are discussed below.

FIG. 9 illustrates an implant platform 14 according to an embodiment. The implant platform 14 comprises a mandible facing surface 16 for engaging the lower mandible and an abutment receiving surface 24. The abutment receiving surface 24 is also referred to as the upper surface of the implant. The abutment receiving surface 24 comprises a projection 20 for receiving an abutment. As shown the projection 20 is substantially cylindrical in geometry. In some embodiments, the abutment receiving surface 24 of the implant platform 14 also comprises at least one projection for engaging with the strap 40.

In the embodiment shown in FIG. 9A and FIG. 9B the implant platform 14 comprises a curved upper surface 24. The curved upper surface 24 allows the strap to drape over the surface with the curvature preventing bending or kinking of the strap 40. The curvature of the upper surface further ensures that the strap 40 sits closely against the bone of the lower mandible, increasing the contact area between the strap 40 and the bone of the lower mandible. Increased surface area is beneficial for osseointegration of the strap 40 with the bone of the lower mandible.

The implant platform 14 comprises a mandible facing surface 16 at the underside of the implant platform 14. The mandible facing surface 16 is also referred to herein as the base surface 16. The implant platform 14 has a projection 18, or spigot, on the mandible facing surface 16. Protrusion 18 is for insertion into a hole, usually drilled, in the mandible 10. Projection 18 is cylindrical with a frusto-conical termination. In use, the projection 18 extends into the mandible restricting lateral movement of the implant platform 14 relative to the mandible 10.

In an embodiment, the mandible facing surface 16 of the implant platform 14 comprises a plurality of spikes 22 for engaging the bone of the mandible at the site 12. The spikes 22 further stabilise the implant platform 14, preventing lateral movement and rotation of the implant platform 14 relative to the mandible 10. The increased surface area provided by the spikes 22, as well as the close contact with the bone, encourage osseointegration between mandible facing surface 16 and the bone at the site 12. As shown, in an embodiment the spikes 22 are in a circular array, and are positioned concentrically about the base projection 18. However it will be understood that the spikes may be in other configurations. The spikes 22 are pyramidical, tetrahedrical, conical protrusions. Other suitable geometries for engaging the bone surface are envisaged.

FIG. 10 shows an implant platform 14 according to an embodiment. The spikes 22 are positioned around the periphery of the base surface 16. The curvature of the upper surface 24 is larger, further protecting the strap from kinking and, when in situ, guiding the strap around the mandible.

FIG. 11A shows an abutment 30 according to an embodiment. The base surface 31 of the abutment 30 is contoured to conform to the upper surface 24 of the implant platform 14. This the abutment 30 can be easily guided into the correct position by the dentist. The abutment 30 may be more elongate or have a reduced height as shown, to suit the position and type of the tooth to be replaced. FIG. 11B shows abutment 30 in position on the implant platform 14. The abutment 30 comprises a receiving portion 33 shaped to receive a crown and to accept a socket head helical screw.

FIG. 12A shows an implant platform 14 according to an embodiment. The implant sides 26 have a smooth rounded surface, making the implant platform 14 more harmonious to surrounding soft tissue than rough surfaces and sharp edges, therefore adverse reaction by the body to the implant platform 14 is minimised. In an embodiment the implant platform 14 further comprises anti-rotation ribs 32 on the projection 20. In the embodiment shown in FIG. 12A the ribs 32 extend in the longitudinal direction of the projection 20 and protrude radially from the projection 20. The ribs 32 prevent an abutment that comprises matching or similar internal grooves from rotating relative to the implant platform 14.

The implant shown in FIG. 12A comprises barbs 28 on the mandible projection 18. In the illustrated embodiment the barbs 28 are formed on ribs that project radially and extend in the longitudinal direction of the mandible projection 18. Embodiments in which the barbs 28 are provided directly on the mandible projection 18 are, however, also envisaged. The barbs 28 provide additional engagement with the bone of the mandible 12 and promote osseointegration. As shown, in the embodiment the barbs 28 have saw-tooth or near saw-tooth shaped profile with a surface 27 inclined at an oblique angle relative to the longitudinal axis of the mandible projection 18. It will be appreciated that the configuration of the surfaces 27 enable easy movement of the mandible projection 18 into a hole drilled into the mandible 10 as the surfaces are inclined away from the direction of insertion into the mandible 10. The barbs 28 also have a surface extending perpendicular or substantially perpendicular to the axis of the mandible projection 18. Thus, in use, surface 29 is parallel or substantially parallel to the base of the implant platform 14. Surface 29 engages the bone should it be the implant be pulled vertically, resisting movement vertically relative to the mandible 10. Thus, the barbs 28 facilitate one-way insertion and resist removal of the implant platform 14. FIG. 12B illustrates the implant platform 14 of FIG. 12A with an abutment positioned on its upper surface 24.

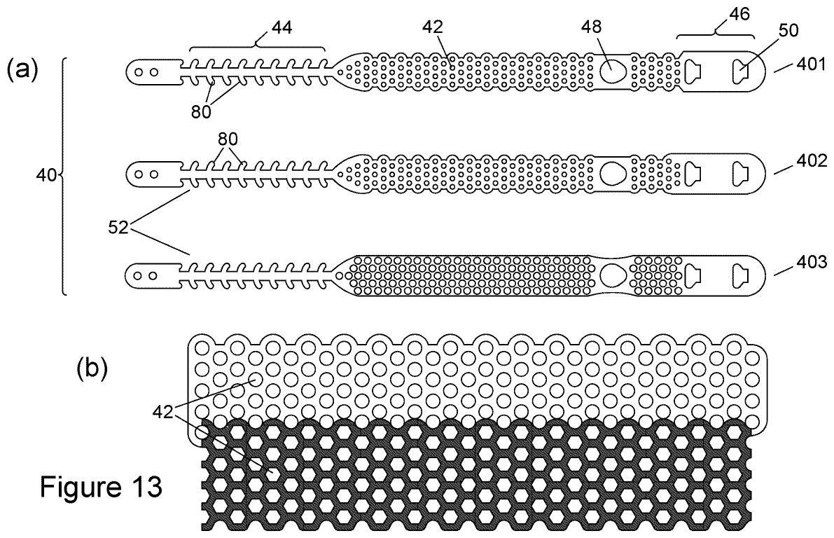

FIG. 13A and FIG. 13B to FIG. 17 are schematics of straps 40 according to embodiments. The straps 40 comprise a length of substantially flat material having two ends and a section which extends therebetween. In an embodiment, the strap 40 is between approximately 0.05 mm and 0.25 mm in thickness. The strap 40 of the embodiment is formed from Titanium, although it will be understood that other suitable materials could be used.

The straps 40 shown comprise a plurality of apertures 42. The apertures 42 are machined into the strap 40 forming a mesh-like geometry. In an embodiment, the apertures are etched into the strap 40. This can, for example, be done using a laser texturing or ablation process or chemical etching process. In an embodiment in place of apertures the strap is formed form a three-dimensional chain mail structure. Minimising the thickness of the strap and adding the apertures make the strap 40 flexible and able to conform to the contours of the mandible 10. The strap 40 is elongate comprising two end portions, the section having apertures extends therebetween.

As depicted in FIG. 13 B, in some embodiments the apertures 42 comprise round holes with a diameter of 0.7 mm and in other embodiments the apertures 42 comprise hexagonal holes across the flats of a width of 0.7 mm. An aperture sizing of approximately 0.7 mm is optimal for promoting osseointegration. Hexagonal apertures provide increased flexibility and stress resistance to the strap 40. As shown in FIG. 13B the apertures 42 can be circular, hexagonal, triangular or any suitable shape.

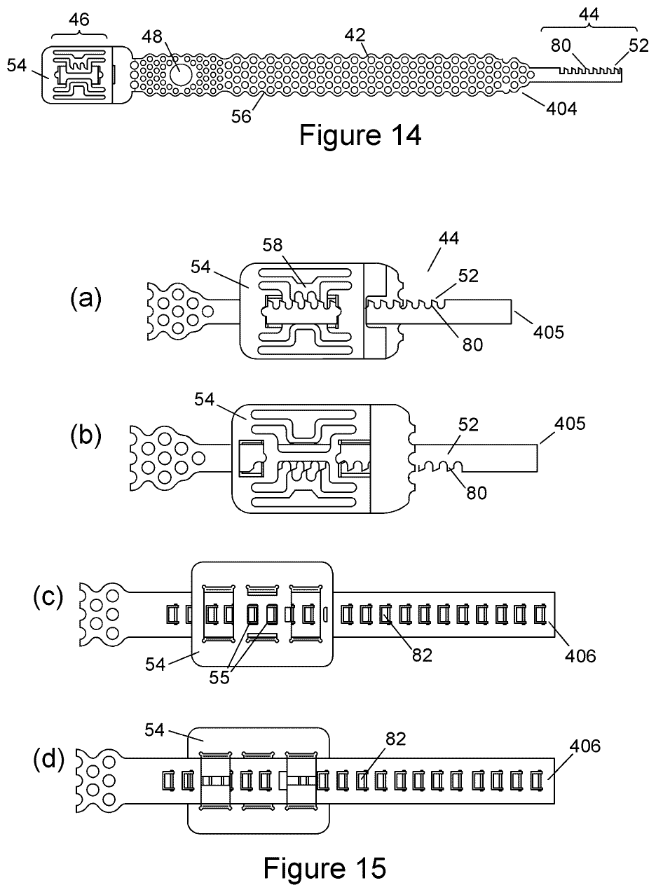

The strap 40 comprises scalloped edges 56, as shown in for example FIG. 14, which extend along the sides of the perforated section. Scalloped edges enable blending to the surrounding bone when in situ, promoting osseointegration between the strap 40 and the bone of the mandible 12.

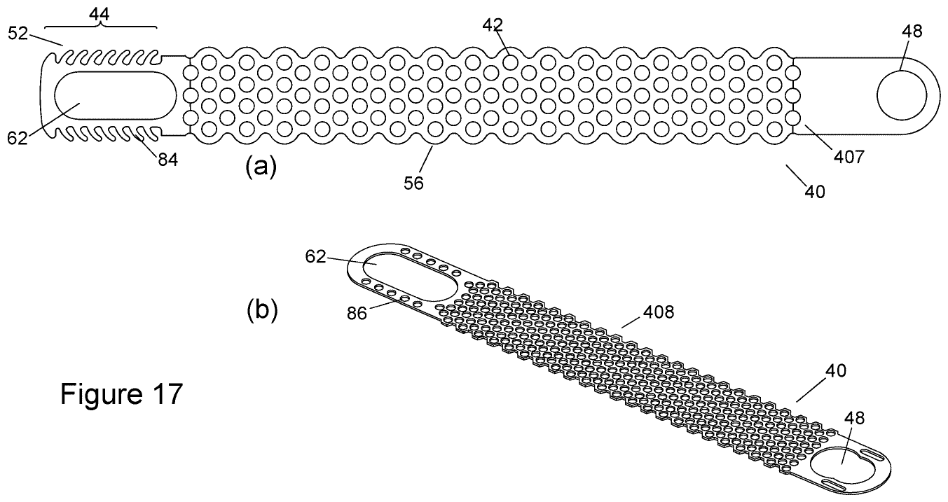

Particular embodiments of the strap 40 will now be discussed. The strap 401, 402 and 403 comprises an opening 48 through which the projection 20 of the implant platform 14 protrudes when in situ. In this way, the strap 401, 402 or 403 can engage the implant platform 14 and affix it to the lower mandible 12. As shown in FIG. 14 and FIG. 17A in some embodiments the strap 404, 407 comprises an opening of substantially circular shape. FIG. 17B shows an alternative embodiment wherein the opening is non-circular or oblong to allow versatility for patient anatomy and ease of fitting for the dentist.

The strap 40 comprises an engaging and receiving mechanism. As shown in FIG. 13A, an end portion of the strap 401, 402 and 403 comprises a barbed section 44. The barbed section 44 comprises a plurality of engagement features 52. As shown in FIG. 13A in an embodiment the engagement features 52 comprise a plurality of cantilever locking arms 80 oriented in two opposing directions. The opposite end of the strap 40 comprises a receiving section 46. In the embodiment shown in FIG. 13A, straps 401, 402 and 403 comprise a receiving section 46 having a pair of apertures 50 suitable for receiving the barbed section 44. The barbed section can be inserted through both apertures 50 and the cantilever arms 80 engage the periphery of the apertures 50 and thereby locking the ends of the strap together.

In the embodiment shown in FIG. 13A the plurality of cantilever locking arms 80 provide a series of sizing options to suit mandibles of different sizes. Depending on the required length of the strap 401, 402 or 403 the appropriate cantilever arms 80 are engaged. The apertures 50 have a wide section, proximate to the perforated section of the strap 401, 402 or 403, and through which the barbed section 44 can fit. The apertures 50 also have a narrow section proximate to the end of the strap 401, 402 and 403, and which is too narrow for the barbed section 44 to fit through. In use, the barbed section is inserted into the wider section of the aperture 50 and upon being released the strap 401, 402 or 403 sits in the narrow section of the aperture 50. The cantilever locking arms 80 of the barbed section 44 engage the periphery of the narrow section of the aperture 50, securing the strap ends together.

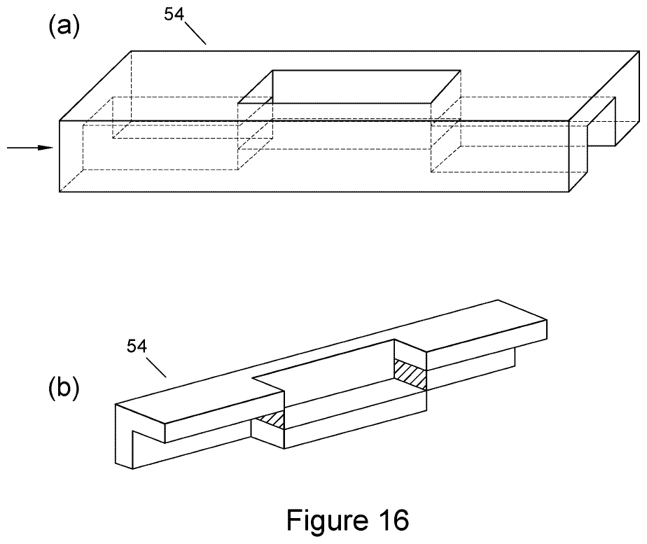

In some embodiments, as shown in FIGS. 14 and 15A to 15D, strap 404, 405 and 406 comprise a receiving section 46 comprising a buckle 54 instead of a receiving aperture. The buckle 54 is suitable for receiving the barbed section 44 of the strap 404, 405, 406. The barbed section 44 of strap 404 and 405 comprises cantilever arms 80 facing in just one direction. The barbed section 44 of strap 406 comprises a plurality of tabs 82, which are out of plane with the rest of the strap 406. The buckle 54 comprises a pair of openings through which the barbed section 44 is woven. In use, the barbed section 44 is inserted through a first opening, from a first face of the buckle and exits the buckle 54 at a second, opposite face. Between the first and second opening the barbed section 44 engages with buckle via engaging portions 58 (FIG. 15A and FIG. 15B) or 55 (FIG. 15C and FIG. 15D). The buckle 54 of straps 404 and 405, shown in FIGS. 14, 15A and 15B comprises an engagement portion of a cantilever section 58 positioned between the openings. The cantilever sections 58 carries and biases engagement teeth towards teeth carried by a respective cantilever spring arms 80 of the barbed section 44, thereby engaging the strap with the buckle 54. The free end of the strap is guided into the engagement mechanism of the buckle 54 (as shown in FIG. 14). As shown in FIGS. 16A and 16B in some embodiments the buckle 54 comprises a 3D structure. FIG. 16B shows a section view of the buckle 54 of FIG. 16A whereby the strap material has been selectively etched from both sides to create rectangular tunnels in a block section, through which the barbed section 44 is guided.

In FIGS. 15C and 15D strap 406 has a barbed section 44 comprising tabs 82 which are which are pushed out of the two-dimensional plane defined the strap 406, for example such that they protrude at an oblique angle to the plane of the strap 406. In this embodiment the buckle 54 comprises two openings 55 which are suitable to receiving the tabs 82 such that the tabs 82 ratchet over them when the strap 406 is tightened around the mandible. Although two holes 55 are shown, it will be appreciated that any suitable number of holes 55 is encompassed. The tabs 82 and holes 55 lock together in a manner similar to that of a zip tie, resisting pulling apart in the direction that would release the barbed section 44 from the buckle 54.

Therefore, the strap 404, 405 and 406 firmly engages the buckle 54 at a plurality of points, thereby increasing stability and spreading the loading over a plurality of points. The buckle 54 is particularly useful for mandibles of smaller geometries where the cantilever locking arms 80 could distend and slip through an aperture 50.

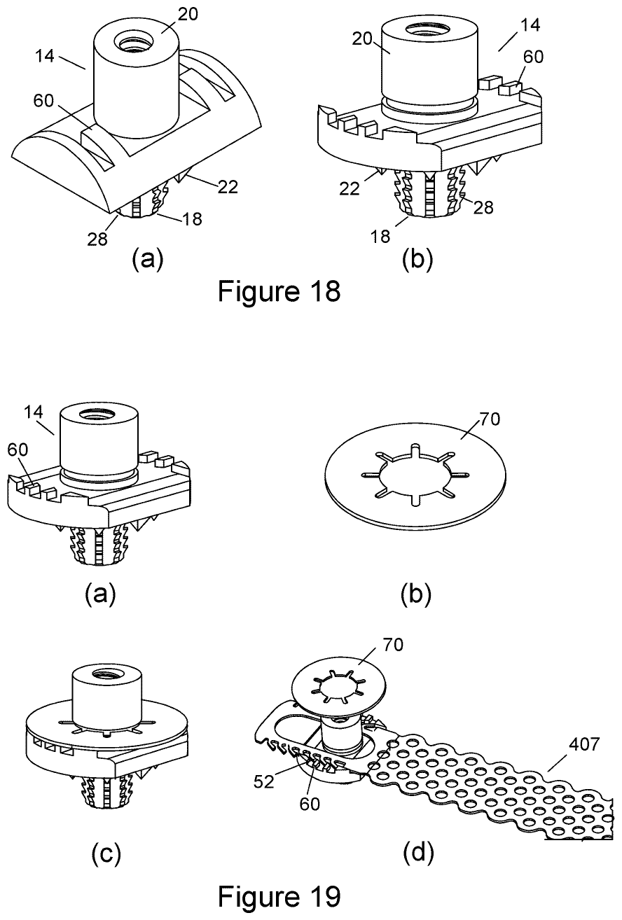

A strap 407 according to another embodiment is shown in FIG. 17A. Opening 48 is configured to be placeable over projection 20 of the implant platform 14 when securing the implant platform 14 to the mandible (as shown in FIG. 3). The barbed section 44 of strap 407 comprises a plurality of cantilever arms 84 in two rows, the cantilever arms 84 of the first row extending in an opposite direction to the cantilever arms 84 of the second row. The barbed section 44 comprising an elongate opening 62 positioned between the rows as shown in FIG. 17A. The elongate opening 62 is configured to loop over the projection 20 of the implant platform 14 after the strap 40 has been looped around the mandible, as shown in FIG. 4. The cantilever arms 84 of the barbed section 44 are designed to flex and engage with matching features 60 on the implant platform 14, for example the protrusions 60 shown in FIGS. 18A and 18B.

In an alternative embodiment, shown in FIG. 17B, in place of a barbed section the strap 408 comprises two rows of apertures 86 instead of the rows of cantilever arms 84 of strap 407. The rows of apertures 86 are configured to engage with matching features 60 on the implant platform 14, securing the second end of the strap 408 in position.

As illustrated in FIGS. 18A and 18B, embodiments of the implant platform comprise protrusions 60 on the upper surface 24 of the implant platform 14 which are suitable for engaging with the cantilever arms 84 or openings 86 (as referenced in FIG. 20D). As shown in FIG. 19D the arms 84 of the strap 407 engage the protruding features 60 of the implant platform 14. In an embodiment there are four protrusions 60 on upper surface 24 of the implant platform. Preferably there are approximately six protrusions 60 to spread load and reduce risk of material being sheared off. As can be seen from the embodiment illustrated in FIG. 18A, it is envisaged for the protrusions 60, or at least the protrusions 60 closest to the edge of the implant platform 14 from which the strap 407 is required to approach the implant platform 14 after looping around the mandible, to be curved. The shape of the protrusion 60 thereby enables the cantilever arms 84 to relatively easily glide over the protrusions 60 whilst being tightened about the mandible and implant platform 14. Once the desired tightness has been achieved the user merely needs to move the cantilever arms 84 downwardly towards the top surface of the implant platform 14 to facilitate engagement between the cantilever arms 84 and the protrusions 60.

FIG. 20 shows strap 408 configured to loop over and engage the protrusions 60 on the upper surface 24 of the implant platform 14. The plurality of apertures 86 surround the elongate opening 62, which, in use, loops over the projection 20 of the implant platform 14. It is emphasised that FIG. 20D omits showing engagement of the other end of the strap 408 with the implant platform 14 for clarity of illustration only. It will be appreciated that in use, by the time the engagement shown in FIG. 20D is affected, the other end of the strap 408 has already been placed around the projection 20 and the strap 408 has been looped around the mandible.

In embodiments, the assembly further comprises a retaining washer 70. The retaining washer 70 provides a further securing means. In an embodiment, the retaining washer 70 comprises a flat plate as shown in FIG. 19B. The retaining washer 70 can be circular or polygonal in shape. In an embodiment, the retaining washer 70 is a spring-loaded retaining washer.

The flat plate retaining washer 70 of FIG. 19B has an inner diameter, which is smaller than the outer diameter of the projection 20. Radial cuts are provided along the inner circumference of the retaining washer 70, creating flexible inward facing tongues that flex upwardly when the retaining washer 70 is pushed downwardly over the projection 20 despite its small inner diameter, thereby permitting the retaining washer 70 to be applied over the projection 20. The projection 20 comprises a circumferential groove with a diameter that is approximately the same or smaller than the inner diameter of the retaining washer 70. Thus, the retaining washer 70 can be forced downwards onto the projection 20 until it reaches the groove and engages with it in a snap-fit type action. In an embodiment, the retaining washer 70 may be so sprung as to allow strap 408 to slide over protrusions 60 but not in opposite direction, when the retaining washer 70 is in situ.

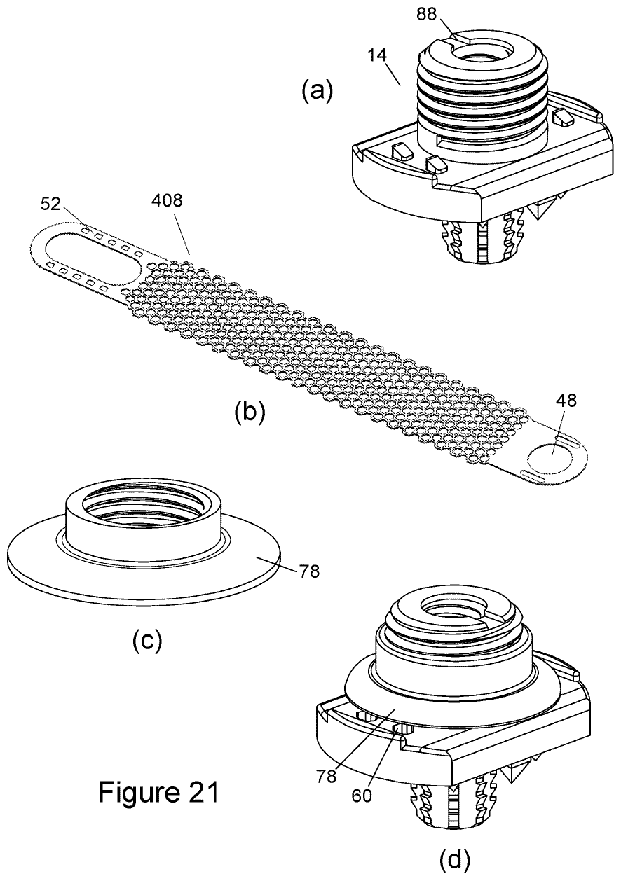

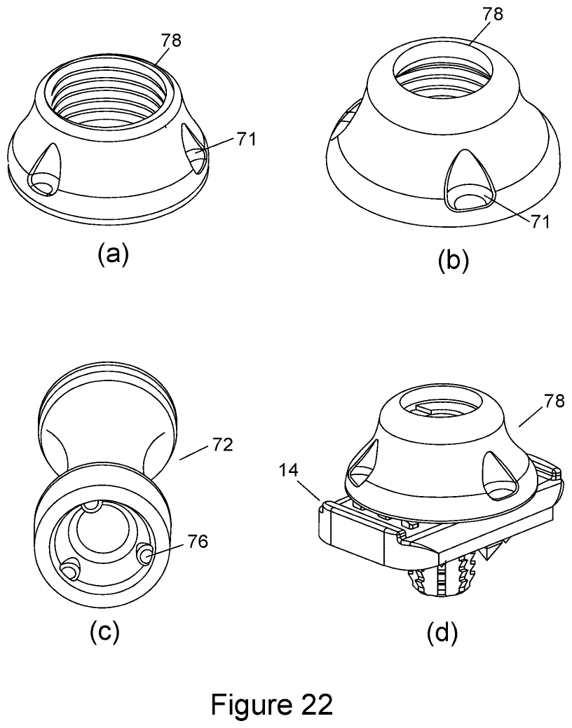

Alternatively, as illustrated in FIGS. 21C and 22A, 22B and 22C, instead of the retaining washer 70, a threaded ferule 78 is used. The threaded ferule 78 comprises a threaded surface which is securable to a threaded projection 20 of the implant platform 14. By securing the threaded ferule 78 via a threaded surface the connection is smoother allowing soft tissue to blend over the surface. Optionally a plurality of grooves 71 can be provided in the threaded ferule 78, as shown in FIG. 22A to enable the threaded ferule to be screwed in with a tool 72, shown in FIG. 22C, designed to enable screwing down of the threaded ferule 78. Complementary protrusions 76 on the inner surface of the tool 72 coincide with the grooves 71 on the threaded ferule 78. The diameter of a hollow recess in the tool 72 closely matches the outer surface of the threaded ferule 78. The thread on the external surface of the projection 20 of the implant platform 14 is fine to enable a finer feed in and more surface area to spread load through screw thread area, providing increased stability. In an embodiment the external diameter of the thread of projection 20 is 3.5 mm, the standard pitch of helical thread is 0.6 mm and the fine pitch of the helical thread is 0.35 mm.

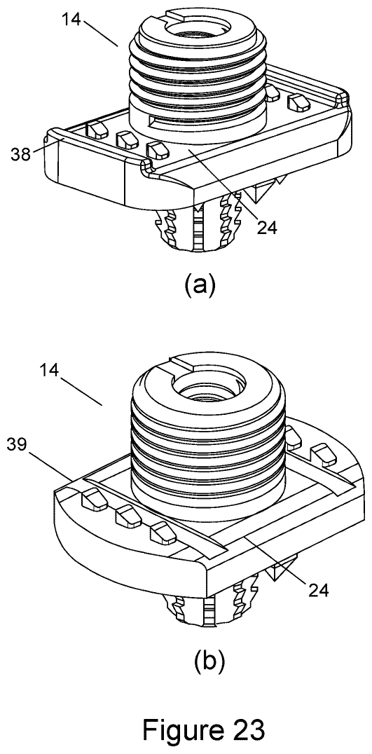

In some embodiments, the thread does not extend to the top of the projection 20 to allow the threaded ferule 78 to cover sharp edges of the threads, protecting surrounding soft tissue. As shown in FIGS. 23A and 23B according to an embodiment, the threaded ferule 78 comprises a smooth and rounded top surface to cover exposed sharp edges of threads to protect soft tissue.

In the embodiments described, hole 48 is placed over the implant projection 20, the strap 40 is then wrapped around the mandible 12 and the elongated hole 62 slipped over the projection 20. In some embodiments, the ends of the strap 40 are rounded, for example strap 401, 402 and 403 as shown in FIG. 13A. In some embodiments one or both ends of the strap 40 are squared off, for example strap 407 shown in FIG. 17A, to enable an increased number of engagement features 52 to be added, thus increasing the number of engagement points between the strap 407 and the upper surface 24 of the implant platform 14.

Alternative embodiments of the implant platform 14 are shown in FIGS. 23A and 23B. As shown in FIG. 23A the upper surface 24 of the implant platform 14 comprises side walls 38 to guide the strap 40 and reduce risk of the strap 40 spreading. This is particularly useful with use of strap 408, where the material either side of the elongated slot 62 is thin and engagement of the aperture opening 86 with protrusions 60 could cause elongated slot 62 to deform and become loose. The side walls 38 stabilise the strap. Similarly, in the embodiment shown in FIG. 23B the implant platform 14 comprises an alignment groove 39 for the same purpose, allowing for a snug fit between the sides of the elongated slot 62 and the implant platform 14.

FIG. 21A shows alignment notch 88 on the projection 20. The alignment notch aids the positioning and orientation of the crown or bridge.

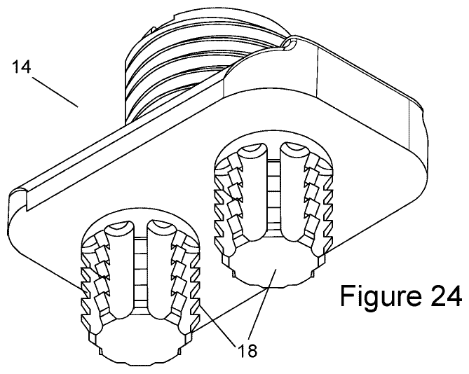

In a further embodiment shown in FIG. 24, the implant platform 14 comprises more than one mandible projection 18. The projections 18 prevent rotation of the implant platform 14 relative to the mandible 10 and are thus useful for many situations where this is a risk due to the available bone structure or the patient's anatomy.

In any of the embodiments described the surface of the implant platform 14 and or strap 40 is a smooth and/or polished surface to allow the soft tissue to smooth over. In an embodiment the surface is coated with Titanium Nitride which provides a low friction surface. Alternatively, the surface of the implant platform 14 or strap 40 in any of the embodiments is roughened. A roughened surface enhances osseointegration. In any of the embodiments described the some or all surfaces are coated in Hydroxyapatite, which provides a surface structure which is known to enhance osseointegration.

Whilst certain embodiments have been described, these embodiments have been presented by way of example only and are not intended to limit the scope of the inventions. Indeed, the novel devices, and methods described herein may be embodied in a variety of other forms; furthermore, various omissions, substitutions and changes in the form of the devices, methods and products described herein may be made without departing from the spirit of the inventions. The accompanying claims and their equivalents are intended to cover such forms or modifications as would fall within the scope and spirit of the inventions.

1. A dental implant comprising an implant platform and a strap, wherein the strap is suitable for encircling a lower mandible so as to affix the implant platform to the lower mandible.

2. The dental implant of claim 1 wherein the strap is a flexible sheet and/or wherein the strap has a plurality of apertures forming a mesh.

3. (canceled)

4. (canceled)

5. The dental implant of claim 1, wherein the strap comprises a means for engaging the implant platform and/or wherein the strap is made from metal.

6. (canceled)

7. The dental implant of claim 1, wherein the implant platform comprises a projection for insertion into a mandible.

8. The dental implant of claim 1, wherein the implant platform comprises an abutment receiving portion for receiving an abutment for receiving a crown.

9. The dental implant of claim 1, wherein the implant platform comprises a means for engaging with the strap and/or vice versa and/or wherein the dental input further comprises an abutment suitable for receiving a crown.

10. The dental implant of claim 1, wherein the implant platform comprises a means for stabilising the implant platform relative to the mandible.

11. The dental implant of claim 10, wherein the means for stabilising the implant platform comprises barbs on the projection.

12. The dental implant of claim 10, wherein the means for stabilising comprises anti-rotation spikes on a mandible-facing surface of the implant platform.

13. The dental implant of claim 1, wherein any or all components of the dental implant are coated with a material to promote osseointegration and/or wherein any or all component are coated or part-coated with a material to reduce friction between the implant and soft tissue of the lower mandible.

14. (canceled)

15. (canceled)

16. An implant platform suitable for use as part of the dental implant of claim 1.

17. An implant platform comprising a receiving portion for receiving a dental prosthesis, the implant platform comprising an attachment means configured to engage a strap to allow the strap to affix the implant platform to a mandible of a patient.

18. A strap suitable for use as part of the dental implant of claim 1.

19. A strap for affixing an implant platform to a mandible, the strap comprising a substantially flat flexible sheet and a means for engaging the implant platform, the strap configured to wrap around the mandible and affix the implant platform to the mandible.

20. A strap for affixing an implant platform to a mandible, the strap being of a length great enough to encircle a portion of the mandible and comprising means for engaging with the implant platform, the strap being configured such that when the strap encircles the mandible, said means can engage with the implant platform and hold the implant platform in position against the mandible.

21. A strap according to claim 20, wherein the means for engaging with the implant platform are provided at the ends of the strap and/or wherein the means for engaging with the platform are configured to allow tightening of the strap around the lower mandible whilst holding the implant platform in position.

22. (canceled)

23. A dental implant comprising the implant platform and the strap according to claim 18.

24. A kit of parts comprising a dental implant and a tool, wherein the implant comprises a strap and an implant platform, wherein the strap is suitable for affixing the implant platform to a mandible of a patient, wherein the tool is suitable for implanting the implant onto the mandible.

25. A kit of parts according to claim 24, wherein the strap is suitable for encircling the mandible so as to affix the implant platform to the mandible and/or wherein the implant platform comprises a receiving portion for receiving a dental prosthesis, the implant platform comprising an attachment means configured to engage the strap to allow the strap to affix the implant platform to the mandible of a patient.

26. (canceled)

27. A non-volatile memory storing computer instructions for execution by an additive manufacturing device, the computer instructions, when executed by the additive manufacturing device causing the additive manufacturing device to manufacture an implant platform or strap according to claim 1.
